(19) United States
(12) Patent Application Publication
(10) Pub. No.: US 2007/0237914 A1
(43) Pub. Date: Oct. 11, 2007

(54) Cores for pressure-sensitive adhesive tape, and methods for making same

(75) Inventors: David E. Rhodes, Hartsville, SC (US); Tony F. Rummage, Hartsville, SC (US); Xiaokai Niu, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/398,029

(22) Filed: Apr. 5, 2006

(51) Int. Cl. B32B 27/10

(52) U.S. Cl. 428/34.2

(57) ABSTRACT

A core for pressure-sensitive adhesive tape comprises a structural portion such as a wound paperboard tube, and a polymer film ply wrapped about the outer surface of the structural portion and adhered thereto. The polymer film ply has a release coating on its outer surface to allow an adhesive tape wound onto the core to readily and cleanly release from the core during unwinding. The polymer film ply has a lap joint between its opposite edges. The lap joint can be ultrasonically welded during formation of the tape core. Alternatively, the release coating along the underlying edge of the lap joint is removed by a solvent prior to formation of the lap joint.

### BACKGROUND OF THE INVENTION

The present invention relates to cores for pressure-sensitive adhesive tape, and to methods for making such cores.

Pressure-sensitive adhesive tapes are commonly wound onto cores formed from paperboard. When the tail end of the tape that is directly in contact with the paper surface of the core is peeled off the core, some of the paper fibers stick to the adhesive side of the tape, which renders the tail end unsuitable for use. This is always undesirable, but particularly so in the case of “single-use” tape rolls such as medical tape that may have as little as 12 inches of tape wound about the core. It is desirable to be able to use all of the tape wound about the core.

A number of techniques have been tried or proposed for eliminating this problem of contamination of the tail end of the tape. An obvious solution is to make the core from a material such as molded plastic or metal, but this is generally too expensive to be practical.

Another approach has been to form the core with an outermost paperboard ply whose outer surface is coated with a release material that allows the tape to be peeled off. With this method, it is difficult to assure that no uncoated paper will be exposed at the outer surface of the core. For example, if the release-coated ply is wound such that there is a gap between the juxtaposed opposite edges of the ply, then uncoated paperboard of the underlying ply is exposed in this gap. The gap can potentially be eliminated by forming perfect butt joints between the juxtaposed edges of the ply, but in practice this is very difficult to do, particularly at high winding speeds. Thus, this is not a feasible solution to the problem.

It has been proposed to address the problem of the gap between the ply edges by first winding a relatively narrow strip of material having a release surface onto the core at the same helical pitch that the outermost release-coated ply is to be wound, and then the outermost ply is wound onto the core such that the juxtaposed edges of the ply fall on the underlying narrow strip. This is a relatively complicated and expensive method.

Another way of eliminating the gap is to overlap the opposite edges of the release-coated outermost ply and bond the overlapping edges together with adhesive. The problem with this technique is that the release coating on the outer surface of the ply makes it difficult to achieve a firm bond between the overlapping edges of the ply.

Yet another method that has been tried involves winding a non-paper film (e.g., cellophane, polypropylene, or the like) onto the paper core and adhering it to the core such that the outer surface of the core is completely covered by the film. The film edges can be overlapped to ensure that no paper fibers are exposed at the outer surface of the core. However, when the core is cut to desired lengths, the film overlap joint tends to delaminate, which can expose paper fibers at the cut end of the core. Furthermore, it is generally necessary for the film ply to have a release coating on its outer surface, and as noted above, the release coating interferes with the bonding of the overlapping edges.

### BRIEF SUMMARY OF THE INVENTION

The present invention addresses the above problems and achieves other advantages. In one aspect of the invention, a core for pressure-sensitive adhesive tape in accordance with one embodiment comprises a structural portion comprising a tube having a radially inner surface and a radially outer surface, and a polymer film ply wound about and covering the entire radially outer surface of the structural portion, the polymer film ply having an inner surface adhered to the radially outer surface of the structural portion and an opposite outer surface. The outer surface of the polymer film ply comprises a release material that forms the outer surface of the core about which the adhesive tape is wound. The polymer film ply has opposite edges that overlap each other to form a lap joint. The opposite edges of the polymer film ply are ultrasonically welded together.

The ultrasonically welded lap joint has sufficient peel strength to resist delamination of the joint when the pressure-sensitive adhesive tape is unwound. The release coating does not interfere with the formation of a sufficiently strong ultrasonically welded joint.

The polymer film ply can comprise any of various thermoplastic polymers that are ultrasonically weldable. In one embodiment, the polymer film ply comprises a polymer substrate, a tacky adhesive disposed on one side of the polymer substrate, and a release coating disposed on the opposite side of the polymer substrate. The polymer substrate can comprise polypropylene.

The structural portion of the core can comprise a wound paperboard tube. The tube can comprise a helically wound tube or a convolutely wound tube. The polymer film ply can be helically wound or convolutely wound about the paperboard tube.

In accordance with a further aspect of the invention, a method for making a core for pressure-sensitive adhesive tape comprises the steps of providing a structural portion comprising a tube having a radially inner surface and a radially outer surface, winding a polymer film ply about the structural portion such that the polymer film ply covers the entire radially outer surface thereof, and adhering the polymer film ply to the radially outer surface. The polymer film ply has an outer surface comprising a release material that forms the outer surface of the core about which the adhesive tape is wound, the polymer film ply being wound such that opposite edges of the polymer film ply overlap each other to form a lap joint. The method further comprises the step of ultrasonically welding the opposite edges of the polymer film ply together.

The step of providing the structural portion can comprise forming a wound paperboard tube by helically or convolutely winding paperboard material about a cylindrical mandrel and adhering the paperboard material together. The polymer film ply is helically or convolutely wound about the paperboard tube.

In another embodiment of the invention, the method comprises winding a polymer film ply about the structural portion. The polymer film ply comprises a polymer substrate having an inner surface and an outer surface, a tacky adhesive disposed on the inner surface to adhere the polymer film ply to the radially outer surface of the structural portion, and a coating of a release material disposed on the outer surface of the polymer substrate. The polymer film ply is wound such that a first edge of the polymer film ply overlaps an opposite second edge of the polymer film ply to form a lap joint. The method comprises contacting the second edge of the polymer film ply with a chemical to dissolve and remove the release material from the polymer substrate along the second edge prior to forming the lap joint, such that the tacky adhesive bonds the first and second edges together without interference from the release material.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 2 is a cross-sectional view through a portion of the wall of a tape core in accordance with one embodiment of the invention, in the location of the lap joint of the polymer film ply;

FIG. 3 is a diagrammatic depiction of an apparatus for making tape cores in accordance with one embodiment of the invention;

FIG. 4 is a diagrammatic depiction of an apparatus for making tape cores in accordance with an alternative embodiment of the invention;

FIG. 5 is a view similar to FIG. 2, showing a tape core made in accordance with the process of FIG. 4; and

FIG. 6 is a tape core in accordance with another embodiment of the invention.

### DETAILED DESCRIPTION OF THE INVENTION

The present inventions now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

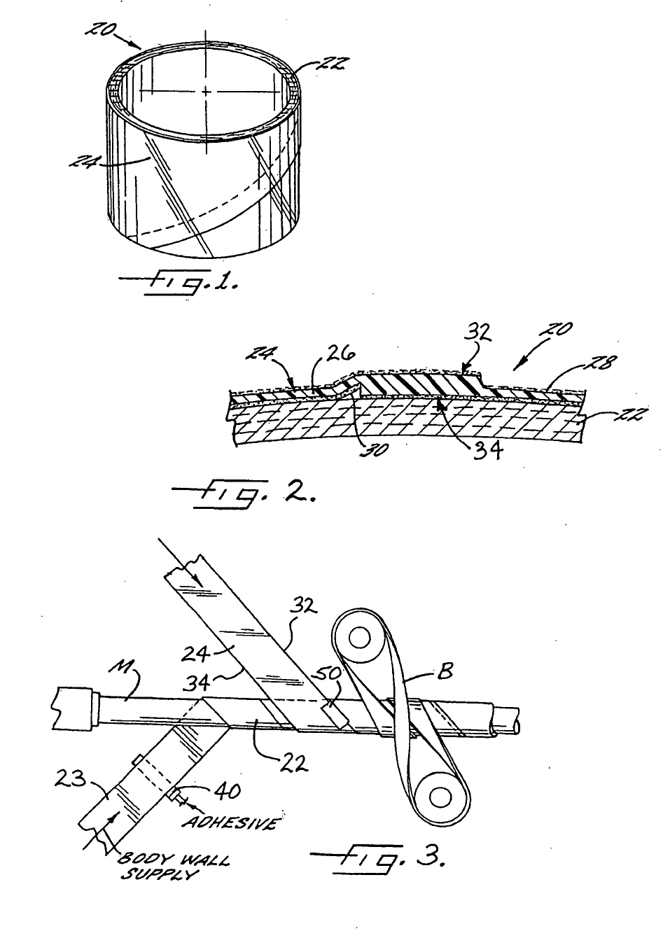

A tape core 20 in accordance with one embodiment of the invention is shown in FIG. 1 showing a perspective view of the core, and FIG. 2, which illustrates a magnified, fragmentary cross-sectional view through the tape core wall in the vicinity of the lap joint of the polymer film ply. The core 20 comprises a structural portion 22 that provides structural strength and integrity to the core. The structural portion can be formed in various ways and of various materials. In one embodiment, as illustrated, the structural portion is formed of fibrous material such as paperboard. For example, the structural portion can comprise a helically or convolutely wound paperboard tube, as further described below.

The core 20 further comprises an outer polymer film ply 24 that is wrapped about the radially outer surface of the structural portion 22 and adhered thereto with a pressure-sensitive adhesive. In accordance with one embodiment of the invention, the polymer film ply 24 comprises a polymer substrate 26 having a release coating 28 on its outer surface, and a tacky adhesive 30 on its inner surface for adhering the polymer film ply to the structural portion 22. The release coating 28 forms the outermost surface of the tape core 20 upon which adhesive tape or the like is to be wound.

The polymer film ply 24 can comprise various materials. The polymer substrate 26 can comprise a polyolefin such as polypropylene or polyethylene. The release coating 28 can comprise any suitable material that tacky adhesives will readily release from, including but not limited to solvent-based urethanes, water-based silicones (optionally containing additives such as polyurethane), and the like. The selection of the release coating 28 generally will depend upon the properties of the particular tacky adhesive 30 employed. Various tacky adhesives can be used.

In one embodiment, the polymer film ply 24 comprises a carton-sealing tape comprising a polypropylene (e.g., BOPP) substrate 26 having a solvent-based urethane release coating 28 and a pressure-sensitive adhesive 30 (e.g., a hot melt rubber-resin PSA). In another embodiment, the release coating comprises a water-based silicone and polyurethane composition.

The polymer film ply 24 is wrapped about the structural portion 22 such that opposite edges 32 and 34 of the ply overlap to form a straight lap joint as indicated in FIG. 1. The ply 24 thus advantageously covers the entire outer surface of the structural portion. Although there is an exposed side edge of the substrate overlying edge 32 that is not coated with the release coating, the substrate 26 is very thin and hence the edge of the substrate does not present a problem in terms of the adhesive tape product sticking to the edge and preventing ready release of the tape from the core.

In accordance with the illustrated embodiment of FIG. 2, the overlapping edges of the polymer film ply 24 are ultrasonically welded together. This is schematically depicted in FIG. 2 by a single continuous polymer region formed by a melding of the individual layers of the overlapping edges. The ultrasonic welding process employs high-frequency vibration to melt the polymer material of the overlapping edges. The polymer material from the initially separate layers generally blends together such that, upon subsequent cooling, the edges are firmly bonded together.

FIG. 3 illustrates an apparatus and process for making tape cores in accordance with the embodiment of FIG. 2. The process is a spiral or helical winding process similar to that used for making various helically wound tubes. The apparatus includes a cylindrical mandrel M about which plies of flexible materials are helically wrapped and adhered together to form a tube on the mandrel. The tube is advanced in screw fashion along the mandrel with a winding belt B as in conventional spiral tube-forming machines. The tube is formed from a plurality (only one shown in FIG. 3 for clarity purposes) of body plies 23 of a material having substantial structural strength and integrity, such as paperboard or the like. Each body ply 23 is advanced from a supply (e.g., a roll of the body ply mounted in an unwind stand) toward the mandrel M and is helically wrapped about the mandrel. Adhesive is applied to each of the body plies 23, such as by an adhesive applicator 40, and the body plies are wrapped one upon another (and typically axially staggered relative to each other) such that the plies are adhered together to form the structural portion 22 of the tape core in the form of a helically wound tube, such as a paperboard tube.

The process further comprises helically wrapping the polymer film ply 24 about the tube 22 formed on the mandrel. In particular, the polymer film ply 24 is advanced from a supply (e.g., a roll of the polymer film ply mounted in an unwind stand) toward the mandrel and is helically wrapped about the tube 22. The screw-wise movement of the tube 22 along the mandrel provides the force that draws the body plies 23 and polymer film ply 24 from their respective supplies and causes them to helically wrap about the mandrel. Ply guides (not shown) guide the plies to the mandrel and help ensure that the plies are wrapped at the correct helical angle. The polymer film ply 24 includes its own tacky adhesive layer on its underside, as previously described, such that the polymer film ply is adhered to the outer surface of the tube 22. The polymer film ply is wrapped such that a first edge 32 of the ply overlaps the opposite second edge 34 by a suitable amount to ensure that, given the expected inaccuracies in controlling the precise positioning of the edges, there will always be a lap joint between the edges 32, 34 (i.e., there will never be a butt joint or a gap between the edges).

An ultrasonic welding horn (also sometimes referred to as a sonotrode) 50, which is preferably in the form of a rotating roller, presses against the lap joint on the mandrel and ultrasonically welds the edges 32, 34 together. The welding horn 50 is shown as being positioned upstream of the winding belt B, but alternatively it can be downstream of the belt. The mandrel M effectively serves as the “anvil” for the ultrasonic welding device. The edges 32, 34 of the polymer film ply 24 are compressed between the welding horn 50 and the mandrel M, and the horn emits high-frequency vibrations (typically in the range of about 15 to 40 kHz, depending on the type of material being welded, the weld joint geometry, the power output of the welding horn, and other factors) that are directed into the polymer material and cause intermolecular vibrations that plasticize the polymer material—i.e., the polymer material “melts” and flows together from the overlapping layers of the film ply. The plasticized zone, or weld zone, is generally quite localized and generally corresponds to the “footprint” of the welding horn 50 on the polymer film ply. The welding horn can be configured in any fashion to contact the desired amount of surface area of the polymer film ply. Thus, although in FIG. 2 the weld zone is schematically shown as occupying the entire width of the lap joint, the welding horn can be configured such that the weld zone occupies only a fraction of the lap joint width. Upon cooling, the edges 32, 34 are firmly bonded together via the weld zone.

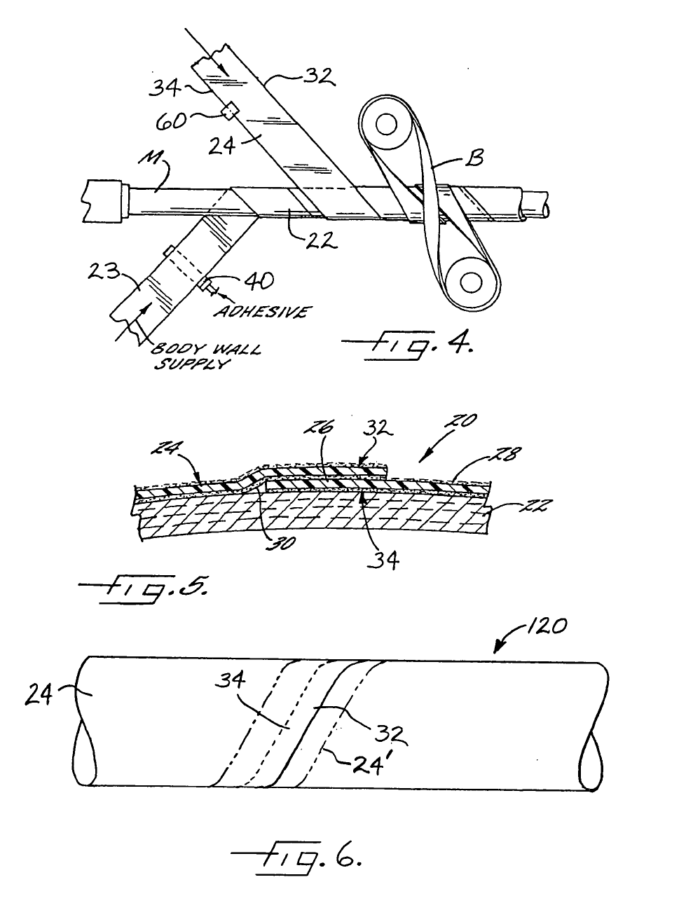

FIG. 4 depicts an apparatus and process in accordance with an alternative embodiment of the invention. The process is generally similar to that of FIG. 3, except that ultrasonic welding is not employed. Instead, the lap joint of the polymer film ply 24 is secured by the tacky adhesive layer 30 on the film ply. The release coating 28 on the polymer film ply generally would interfere with the attainment of a firm bond. Accordingly, it is necessary to alter the polymer film ply along the second edge 34 so that the overlying edge 32 will firmly adhere to it. In particular, in accordance with this embodiment, the release coating is removed along the second edge 34 prior to the formation of the lap joint.

This is accomplished by contacting the outer surface of the polymer film ply 24 along the second edge 34 by a chemical that dissolves the release coating. For example, as illustrated, a piece of absorbent material 60 saturated with a liquid solvent can be placed in contact with the second edge 34 as the polymer film ply is advanced to the mandrel, so as to dissolve and remove the release coating from the second edge. The absorbent material 60 can comprise a wick or felt material, or any other suitable material capable of absorbing the liquid solvent. Any suitable solvent can be used. When the release coating is a solvent-based urethane composition, the solvent can comprise toluene. When the release coating is a water-based silicone and polyurethane composition, the solvent can comprise methyl ethyl ketone (MEK).

FIG. 5 illustrates the tape core made in accordance with the process of FIG. 4. It can be seen that the release coating 28 has been removed from the edge 34 such that the overlying edge 32 firmly adheres to the polymer substrate 26 of the edge 34 via the tacky adhesive layer 30.

Tape cores in accordance with the present invention have an outer surface formed by the release coating 28 of the polymer film ply 24. Accordingly, the adhesive tape product wound onto the tape core will readily and cleanly release from the tape core such that all of the tape product can be used. Furthermore, even if the tape product is wound onto the tape core in such a manner that unwinding of the tape product is in a direction to tend to peel the overlying edge 32 of the polymer film ply 24 from the underlying edge 34, the lap joint is able to remain intact because of the firm bond provided by the ultrasonic weld (FIG. 2) or the adhesive bond between the tacky adhesive layer 30 and the polymer film substrate 26 (FIG. 5).

A further embodiment of the invention is shown in FIG. 6. The tape core 120 is generally similar to the tape core 20 described above in connection with FIG. 5, except that an additional narrow strip 24′ of the polymer film ply material having the tacky adhesive layer is helically wound about the paperboard tube in an “upside down” orientation prior to winding of the outer polymer film strip 24, such that the tacky adhesive layer of the narrow strip 24′ faces outwardly, away from the paperboard tube. The narrow strip is wound at the same helical wind angle as the outer polymer film strip 24. The outer polymer film strip 24 is wound with an overlap joint as previously described, and the overlap joint is located on the narrow strip 24′. Thus, the tacky adhesive layer of the outer polymer film strip 24 bonds to the outwardly facing tacky adhesive layer of the narrow strip 24′. In the event that unwinding of adhesive tape material from the tape core 120 causes the overlying edge portion 32 of the outer polymer film strip 24 to be lifted from the underlying edge portion 34, the edge 32 can be lifted only until it reaches the underlying narrow strip 24′; further peeling of the edge 32 is prevented by the adhesive-to-adhesive bond between the outer polymer film strip 24 and the underlying narrow strip 24′.

The above-described embodiments of the invention relate to helically wound tape cores. Alternatively, however, the tape cores can be convolutely wound if desired. Convolute winding entails wrapping a sheet of flexible material around the mandrel with the opposite longitudinal edges of the sheet parallel to the mandrel axis. The width of the sheet (i.e., in the direction perpendicular to the longitudinal edges) can be only slightly greater than the mandrel circumference such that the sheet makes only one full turn about the mandrel and a lap joint can be formed between the longitudinal edges, the lap joint extending axially along the mandrel parallel to the mandrel axis. Alternatively, the sheet width can be greater such that the sheet makes a plurality of full turns about the mandrel. In any event, adhesive bonds the lap joint or the adjacent turns of the sheet together. Thus, the structural portion of the tape core can comprise a convolutely wound tube formed by a sheet of body ply material wrapped convolutely for a plurality of turns and adhered together by a suitable adhesive, and a polymer film ply convolutely wrapped about the tube and adhered thereto by a tacky adhesive layer of the polymer film ply, with the axial lap joint of the polymer film ply being ultrasonically welded or adhesively joined as previously described.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A core for supporting a length of pressure-sensitive adhesive tape wound about an outer surface of the core, the core comprising:
a structural portion comprising a tube having a radially inner surface and a radially outer surface, the structural portion providing structural strength and integrity to the core; and
a polymer film ply wound about and covering the entire radially outer surface of the structural portion, the polymer film ply having an inner surface adhered to the radially outer surface of the structural portion and an opposite outer surface, the outer surface of the polymer film ply comprising a release material that forms the outer surface of the core about which the adhesive tape is wound, the polymer film ply having opposite edges that overlap each other to form a lap joint, the opposite edges of the polymer film ply being ultrasonically welded together.

2. The core of claim 1, wherein the structural portion comprises a paperboard tube.

3. The core of claim 2, wherein the paperboard tube comprises a helically wound paperboard tube.

4. The core of claim 2, wherein the paperboard tube comprises a convolutely wound paperboard tube.

5. The core of claim 1, wherein the polymer film ply is helically wound such that the lap joint extends helically along the core.

6. The core of claim 1, wherein the polymer film ply is convolutely wound such that the lap joint extends axially along the core.

7. The core of claim 1, wherein the polymer film ply comprises a polypropylene film.

8. The core of claim 1, wherein the polymer film ply includes a tacky adhesive on the inner surface to adhere the polymer film ply to the structural portion.

9. A core for supporting a length of pressure-sensitive adhesive tape wound about an outer surface of the core, the core comprising:
a structural portion comprising a tube having a radially inner surface and a radially outer surface, the structural portion providing structural strength and integrity to the core;
a relatively narrow polymer film strip having a tacky adhesive layer on one surface thereof, the relatively narrow polymer film strip being helically wound about the tube with the tacky adhesive layer facing outwardly, away from the tube; and
a relatively wide polymer film strip having a tacky adhesive layer on one surface thereof, the relatively wide polymer film strip being helically wound about the tube and the relatively narrow polymer film strip, with the tacky adhesive layer against the tube and the relatively narrow polymer film strip, the relatively wide polymer film strip being wound in such a manner that an overlap joint is formed between opposite edges of the relatively wide polymer film strip, the overlap joint being located on the relatively narrow polymer film strip, the tacky adhesive layer on the relatively wide polymer film strip being bonded to the tacky adhesive layer on the relatively narrow polymer film strip.

10. A method for making a core for supporting a length of pressure-sensitive adhesive tape wound about an outer surface of the core, the method comprising the steps of:
providing a structural portion comprising a tube having a radially inner surface and a radially outer surface, the structural portion providing structural strength and integrity to the core;
winding a polymer film ply about the structural portion such that the polymer film ply covers the entire radially outer surface thereof, and adhering the polymer film ply to the radially outer surface, the polymer film ply having an outer surface comprising a release material that forms the outer surface of the core about which the adhesive tape is wound, the polymer film ply being wound such that opposite edges of the polymer film ply overlap each other to form a lap joint; and
ultrasonically welding the opposite edges of the polymer film ply together.

11. The method of claim 10, wherein the providing step comprises forming a wound paperboard tube to comprise the structural portion.

12. The method of claim 11, wherein the forming step comprises helically winding paperboard material about a cylindrical mandrel and adhering the paperboard material together to 1 the wound paperboard tube.

13. The method of claim 11, wherein the forming step comprises convolutely winding paperboard material about a cylindrical mandrel and adhering the paperboard material together to form the wound paperboard tube.

14. The method of claim 10, wherein the winding step comprises helically winding the polymer film ply about the structural portion such that the lap joint extends helically along the core.

15. The method of claim 10, wherein the winding step comprises convolutely winding the polymer film ply about the structural portion such that the lap joint extends axially along the core.

16. A method for making a core for supporting a length of pressure-sensitive adhesive tape wound about an outer surface of the core, the method comprising the steps of:
providing a structural portion comprising a tube having a radially inner surface and a radially outer surface, the structural portion providing structural strength and integrity to the core;
winding a polymer film ply about the structural portion such that the polymer film ply covers the entire radially outer surface thereof, the polymer film ply comprising a polymer substrate having an inner surface and an outer surface and a tacky adhesive disposed on the inner surface to adhere the polymer film ply to the radially outer surface of the structural portion, and a coating of a release material disposed on the outer surface of the polymer substrate, the release material forming the outer surface of the core about which the adhesive tape is wound, the polymer film ply being wound such that a first edge of the polymer film ply overlaps an opposite second edge of the polymer film ply to form a lap joint; and
contacting the second edge of the polymer film ply with a chemical to dissolve and remove the release material from the polymer substrate along the second edge prior to forming the lap joint, such that the tacky adhesive bonds the first and second edges together without interference from the release material.

17. The method of claim 16, wherein the contacting step comprises placing an absorbent material saturated with the chemical in contact with the second edge of the polymer film ply.

18. The method of claim 17, wherein the forming step comprises helically winding paperboard material about a cylindrical mandrel and adhering the paperboard material together to form a wound paperboard tube to serve as the structural portion, and wherein the polymer film ply is drawn from a film supply and advanced to the mandrel and is helically wound about the paperboard tube formed on the mandrel, and the absorbent material saturated with the chemical contacts the second edge of the advancing polymer film ply.
